(19) United States
(12) Patent Application Publication
(10) Pub. No.: US 2020/0259602 A1
(43) Pub. Date: Aug. 13, 2020

(54) Acknowledgment Frame Delay Duration Setting Method, Apparatus, and System

(71) Applicant: Huawei Technologies Co., Ltd., Shenzhen (CN)

(72) Inventor: Guohai Chen, Nanjing (CN)

(21) Appl. No.: 16/862,034

(22) Filed: Apr. 29, 2020

Related U.S. Application Data
(63) Continuation of application No. PCT/CN2018/112709, filed on Oct. 30, 2018.

(30) Foreign Application Priority Data
Nov. 2, 2017 (CN) 201711064953.4

(51) Int. Cl. H04L 1/18; H04B 7/0452; H04L 1/16; H04W 28/04

(52) U.S. Cl. CPC H04L 1/1858; H04W 28/04; H04L 1/1685; H04B 7/0452

(57) ABSTRACT

An acknowledgment frame delay duration setting method, apparatus, and system related to the field of wireless communications technologies, and where the method includes obtaining first acknowledgment frame delay duration corresponding to a first mobile station (STA), and sending, to the first STA, a first indication frame carrying the first acknowledgment frame delay duration such that the first STA feeds back an acknowledgment frame after a delay of the first acknowledgment frame delay duration when receiving a data frame.

### CROSS-REFERENCE TO RELATED APPLICATIONS

This application is a continuation of International Patent Application No. PCT/CN2018/112709 filed on Oct. 30, 2018, which claims priority to Chinese Patent Application No. 201711064953.4 filed on Nov. 2, 2017. The disclosures of the aforementioned applications are hereby incorporated by reference in their entireties.

### TECHNICAL FIELD

This application relates to the field of wireless communications technologies, and in particular, to an acknowledgment frame delay duration setting method, apparatus, and system.

### BACKGROUND

To meet increased bandwidth requirements of a wireless communications system, a multiple-input multiple-output (MIMO) technology is used in several emerging wireless communications standards such as the Institute of Electrical and Electronics Engineers (IEEE) 802.11 standard such that a plurality of mobile stations (STAs) communicate with one or more access points (APs) by sharing a channel resource, to achieve a high data throughput.

To improve reliability of MIMO communication, when a STA receives a data frame (Packet) sent by an AP, the STA needs to feed back an acknowledgment (also referred to as ACK) frame to the AP to notify the AP that the STA has received the data frame.

During application, a same AP may perform concurrent data transmission with different STAs, and interference is likely to be caused due to the concurrent data transmission. FIG. 1A is a schematic diagram of a conflict between acknowledgment frames according to an example embodiment of this application. As shown in FIG. 1A, when an AP simultaneously receives acknowledgment frames fed back by a plurality of STAs, a conflict (interference) is caused between the acknowledgment frames received by the AP. FIG. 1B is a schematic diagram of a conflict between an acknowledgment frame and a data frame according to an example embodiment of this application. As shown in FIG. 1B, when an AP receives, in a process of sending a data frame to a STA 1, an acknowledgment frame fed back by a STA 2, a conflict (interference) is caused between the acknowledgment frame and the data frame.

Due to interference caused between data, an AP is likely to incorrectly determine that the AP receives no acknowledgment frame sent by a STA, that is, determine that a data frame sent to the STA is lost. Consequently, the AP subsequently polls on the STA whether the STA receives the data frame, causing a waste of wireless communications resources.

### SUMMARY

This application discloses an acknowledgment frame delay duration setting method and apparatus, to resolve a problem in a related technology. The technical solutions are as follows.

According to a first aspect, an acknowledgment frame delay duration setting method is provided. The method is applied to a network device, and the method includes obtaining first acknowledgment frame delay duration corresponding to a first mobile STA, and sending, to the first STA, a first indication frame carrying the first acknowledgment frame delay duration such that the first STA feeds back an acknowledgment frame after a delay of the first acknowledgment frame delay duration when receiving a data frame.

With reference to the first aspect, in a first possible implementation of the first aspect, according to the acknowledgment frame delay duration setting method provided in this embodiment of this application, the network device sends, to the first STA, the first indication frame carrying the first acknowledgment frame delay duration such that when receiving a data frame sent by a first AP associated with the first STA, the first STA feeds back an acknowledgment frame to the first AP after a delay of the first acknowledgment frame delay duration. Because STAs in a same group usually have different acknowledgment frame delay duration, a same AP does not simultaneously receive acknowledgment frames sent by STAs in a same group. This prevents an AP from incorrectly determining, due to a conflict between an acknowledgment frame and a data frame and a conflict between acknowledgment frames, that the AP receives no acknowledgment frame sent by a STA, thereby eliminating polling overheads of the AP, and avoiding a waste of wireless communications resources.

With reference to the first aspect or a first possible implementation of the first aspect, in a second possible implementation of the first aspect, the method further includes obtaining second acknowledgment frame delay duration corresponding to a second STA, where the second STA and the first STA are STAs in a same group, and sending, to the second STA, a second indication frame carrying the second acknowledgment frame delay duration such that the second STA feeds back an acknowledgment frame after a delay of the second acknowledgment frame delay duration when receiving a data frame.

With reference to the first aspect or the second possible implementation of the first aspect, in a third possible implementation of the first aspect, a MIMO controller randomly allocates, based on a degree to which the first STA tolerates a network delay, the corresponding first acknowledgment frame delay duration to the first STA within the degree to which the first STA tolerates the network delay. The network device is the MIMO controller, and before obtaining first acknowledgment frame delay duration corresponding to a first mobile STA, the method further includes allocating the first acknowledgment frame delay duration to the first STA, and the sending, to the first STA, a first indication frame carrying the first acknowledgment frame delay duration includes sending the first acknowledgment frame delay duration to a first access point AP such that the first AP forwards the first acknowledgment frame delay duration to the first STA, where the first AP is an AP associated with the first STA.

With reference to the first aspect, the first possible implementation of the first aspect, or the third possible implementation of the first aspect, in a fourth possible implementation of the first aspect, the MIMO controller may separately set a use count of the acknowledgment frame delay duration, to control a quantity of times the STA uses the acknowledgment frame delay duration after receiving a data frame. Therefore, after the allocating the first acknowledgment frame delay duration to the first STA, the method further includes setting a use count of the first acknowledgment frame delay duration, and sending the use count to the first AP such that the first AP forwards the use count to the first STA.

With reference to the first aspect or the first to the fourth possible implementations of the first aspect, in a fifth possible implementation of the first aspect, in other approaches, because a STA usually needs to feed back an acknowledgment frame to an AP after a Short InterFrame Space (SIFS) after receiving a data frame, an acknowledgment timeout time of the AP is set for the short interframe space. Therefore, after allocating acknowledgment frame delay duration to each STA, the MIMO controller further needs to set, based on the acknowledgment frame delay duration of each STA, an acknowledgment timeout time corresponding to each STA, to prevent an AP from prematurely determining that data is lost and starting a re-sending procedure. To be specific, the network device is the first AP, and before obtaining first acknowledgment frame delay duration corresponding to a first mobile STA, the method further includes receiving first acknowledgment timeout duration corresponding to the first STA that is sent by the MIMO controller, and adding the first STA and the first acknowledgment timeout duration to a prestored correspondence between a STA and acknowledgment timeout duration, and setting, based on the first acknowledgment timeout duration, the first acknowledgment frame delay duration corresponding to the first STA, where the first acknowledgment timeout duration is longer than the first acknowledgment frame delay duration.

With reference to the first aspect or the first to the fifth possible implementations of the first aspect, in a sixth possible implementation of the first aspect, overheads of a frame preamble, a frame header, and the like are reduced due to use of an aggregated frame such that network overheads can be effectively reduced. Therefore, sending, to the first STA, a first indication frame carrying the first acknowledgment frame delay duration includes sending, to the first STA in a form of an aggregated frame, the first indication frame carrying the first acknowledgment frame delay duration, where the aggregated frame further includes a data frame.

With reference to the first aspect or the first to the sixth possible implementations of the first aspect, in a seventh possible implementation of the first aspect, after sending the data frame to the first STA, the method further includes re-sending the data frame to the first STA if receiving, within the first acknowledgment timeout duration, no data frame fed back by the first STA.

With reference to the first aspect or the first to the seventh possible implementations of the first aspect, in an eighth possible implementation of the first aspect, because an acknowledgment timeout time for a STA is set by the MIMO controller based on acknowledgment frame delay duration of the STA, to prevent an AP from prematurely determining that data is lost and starting a re-sending procedure after the MIMO controller cancels the acknowledgment timeout time for the STA, the acknowledgment frame delay duration of the STA further needs to be canceled after the acknowledgment timeout time for the STA is canceled such that the STA and the AP both restore to a default mechanism. The method further includes when receiving a first acknowledgment timeout duration cancelation message for the first STA that is sent by the MIMO controller, sending a first acknowledgment frame delay duration cancelation message to the first STA such that the first STA deletes the stored first acknowledgment frame delay duration, and deleting the first STA and the first acknowledgment timeout duration from the correspondence.

According to a second aspect, an acknowledgment frame delay duration setting method is provided. The method is applied to a first STA, and the method includes receiving a first indication frame sent by a first AP, and obtaining and storing first acknowledgment frame delay duration corresponding to the first STA that is carried in the first indication frame, where the first AP is an AP associated with the first STA, and each time receiving a data frame sent by the first AP, feeding back an acknowledgment frame to the first AP after a delay of the first acknowledgment frame delay duration.

According to the acknowledgment frame delay duration setting method provided in this embodiment of this application, a network device sends, to the first STA, the first indication frame carrying the first acknowledgment frame delay duration such that when receiving a data frame sent by the first AP associated with the first STA, the first STA feeds back an acknowledgment frame to the first AP after a delay of the first acknowledgment frame delay duration. Because STAs in a same group usually have different acknowledgment frame delay duration, a same AP does not simultaneously receive acknowledgment frames sent by STAs in a same group. This prevents an AP from incorrectly determining, due to a conflict between an acknowledgment frame and a data frame and a conflict between acknowledgment frames, that the AP receives no acknowledgment frame sent by a STA, thereby eliminating polling overheads of the AP, and avoiding a waste of wireless communications resources.

With reference to the second aspect, in a first possible implementation of the second aspect, overheads of a frame preamble, a frame header, and the like are reduced due to use of an aggregated frame such that network overheads can be effectively reduced. Therefore, the receiving a first indication frame sent by a first AP includes receiving an aggregated frame sent by the first AP, to obtain the first indication frame and a data frame that are included in the aggregated frame, and feeding back an acknowledgment frame to the first AP after a delay of the first acknowledgment frame delay duration.

With reference to the second aspect or the first possible implementation of the second aspect, in a second possible implementation of the second aspect, a MIMO controller may separately set a use count of the acknowledgment frame delay duration, to control a quantity of times the STA uses the acknowledgment frame delay duration after receiving a data frame. Therefore, the first indication frame further carries a use count corresponding to the first acknowledgment frame delay duration, and obtaining and storing first acknowledgment frame delay duration corresponding to the first STA that is carried in the first indication frame includes obtaining and storing the first acknowledgment frame delay duration corresponding to the first STA and the use count corresponding to the first acknowledgment frame delay duration that are carried in the first indication frame, and feeding back an acknowledgment frame to the first AP after a delay of the first acknowledgment frame delay duration includes subtracting 1 from the stored use count corresponding to the first acknowledgment frame delay duration, and if a result obtained after 1 is subtracted from the use count corresponding to the first acknowledgment frame delay duration is less than 0, deleting the first acknowledgment frame delay duration and the use count corresponding to the first acknowledgment frame delay duration, and feeding back the acknowledgment frame to the first AP after a delay of default delay duration, or if a result obtained after 1 is subtracted from the use count corresponding to the first acknowledgment frame delay duration is not less than 0, feeding back the acknowledgment frame to the first AP after a delay of the first acknowledgment frame delay duration.

According to a third aspect, an acknowledgment frame delay duration setting apparatus is provided. The apparatus is applied to a network device, and the apparatus includes an obtaining module configured to obtain first acknowledgment frame delay duration corresponding to a first mobile STA, and a sending module configured to send the first acknowledgment frame delay duration to the first STA such that the first STA feeds back an acknowledgment frame after a delay of the first acknowledgment frame delay duration when receiving a data frame.

According to a fourth aspect, an acknowledgment frame delay duration setting apparatus is provided. The apparatus is applied to a first STA, and the apparatus includes a receiving module configured to receive a first indication frame sent by a first AP, and obtain and store first acknowledgment frame delay duration corresponding to the first STA that is carried in the first indication frame, where the first AP is an AP associated with the first STA, and a feedback module configured to, each time a data frame sent by the first AP is received, feed back an acknowledgment frame to the first AP after a delay of the first acknowledgment frame delay duration.

According to a fifth aspect, a network device is provided. The network device includes a processor and a memory, the memory stores at least one instruction, and the at least one instruction is loaded and executed by the processor to implement corresponding steps in the acknowledgment frame delay duration setting method according to the first aspect.

According to a sixth aspect, a first STA is provided. The first STA includes a processor and a memory, the memory stores at least one instruction, and the at least one instruction is loaded and executed by the processor to implement corresponding steps in the acknowledgment frame delay duration setting method according to the second aspect.

According to a seventh aspect, an acknowledgment frame delay duration setting system is provided. The system includes a network device and a STA, the network device includes the acknowledgment frame delay duration setting apparatus according to the third aspect, or the network device includes the network device according to the fifth aspect, and the STA includes the acknowledgment frame delay duration setting apparatus according to the fourth aspect, or the STA includes the first STA according to the sixth aspect.

According to an eighth aspect, a computer-readable storage medium is provided. The computer-readable storage medium stores at least one instruction, and the at least one instruction is loaded and executed by a processor to implement the acknowledgment frame delay duration setting method according to any one of the first aspect or the possible implementations of the first aspect.

According to a ninth aspect, a computer-readable storage medium is provided. The computer-readable storage medium stores at least one instruction, and the at least one instruction is loaded and executed by a processor to implement the acknowledgment frame delay duration setting method according to any one of the possible implementations of the second aspect.

### BRIEF DESCRIPTION OF DRAWINGS

To describe the technical solutions in some of the embodiments of this application more clearly, the following briefly describes the accompanying drawings describing some of the embodiments. The accompanying drawings in the following description show merely some embodiments of this application, and a person of ordinary skill in the art may still derive other drawings from these accompanying drawings without creative efforts.

FIG. 1A is a schematic diagram of a conflict between acknowledgment frames according to an example embodiment of this application;

FIG. 1B is a schematic diagram of a conflict between an acknowledgment frame and a data frame according to an example embodiment of this application;

FIG. 2A is a schematic diagram of a system architecture of an acknowledgment frame delay duration setting system to which an embodiment of this application is applied;

FIG. 2B, FIG. 2C, FIG. 2D, and FIG. 2E are schematic diagrams of manners in which an AP is connected to a MIMO controller and to which an embodiment of this application is applied;

FIG. 3 is a schematic structural diagram of a network device to which an example embodiment of this application is applied;

FIG. 4 is a schematic structural diagram of a first STA to which an example embodiment of this application is applied;

FIG. 5A is a flowchart of an acknowledgment frame delay duration setting method according to an example embodiment of this application;

FIG. 5B is a schematic diagram of acknowledgment frames received by a first AP according to an example embodiment of this application;

FIG. 6A and FIG. 6B are a flowchart of an acknowledgment frame delay duration setting method according to another example embodiment of this application;

FIG. 7A and FIG. 7B are a flowchart of an acknowledgment frame delay duration setting method according to still another example embodiment of this application;

FIG. 8 is a flowchart of an acknowledgment frame delay duration setting method according to yet another example embodiment of this application;

FIG. 9A and FIG. 9B are a schematic diagram of comparison between an existing data transmission procedure and a data transmission procedure in this application according to an example embodiment of this application;

FIG. 10 is a possible schematic structural diagram of a network device according to an embodiment of this application;

FIG. 11 is a simplified schematic diagram of a possible design structure of a first STA according to an embodiment of this application;

FIG. 12A is a block diagram of an acknowledgment frame delay duration setting apparatus according to an embodiment of this application;

FIG. 12B is a block diagram of an acknowledgment frame delay duration setting apparatus according to an embodiment of this application;

FIG. 13A is a block diagram of an acknowledgment frame delay duration setting apparatus according to another embodiment of this application; and

FIG. 13B is a block diagram of an acknowledgment frame delay duration setting apparatus according to another embodiment of this application.

### DESCRIPTION OF EMBODIMENTS

To make the objectives, technical solutions, and advantages of this application clearer, the following further describes the implementations of this application in detail with reference to the accompanying drawings.

A “module” mentioned in this specification is a program or an instruction that is stored in a memory and that can implement some functions. A “unit” mentioned in this specification is a functional structure obtained through logic-based division. The “unit” may be implemented by only hardware, or implemented by a combination of software and hardware.

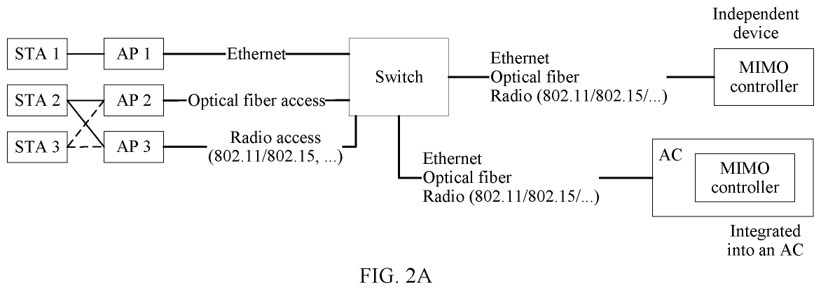

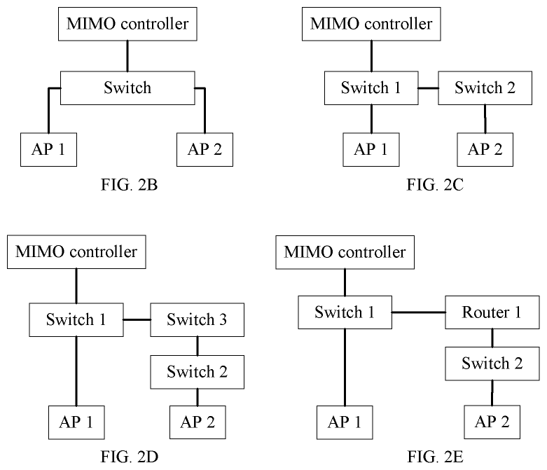

FIG. 2A is a schematic diagram of a system architecture of an acknowledgment frame delay duration setting system to which an embodiment of this application is applied. An acknowledgment frame delay duration setting method in this application is applied to the acknowledgment frame delay duration setting system. The acknowledgment frame delay duration setting system includes a plurality of network devices and a plurality of STAs. The network device includes at least one MIMO controller and at least one AP.

The AP is wirelessly connected to the STA, and the AP is connected to the MIMO controller using a switch. The switch is connected to both the AP and the MIMO controller in a wired/wireless manner. A wired connection manner includes an optical fiber connection and an Ethernet connection.

It should be noted that, a quantity of switches between the AP and the MIMO controller is not limited in the system architecture of the acknowledgment frame delay duration setting system. FIGS. 2B-2E are schematic diagrams of manners in which an AP is connected to a MIMO controller and to which an embodiment of this application is applied. The AP is connected to the MIMO controller using one switch (as shown in FIG. 2B, both an AP 1 and an AP 2 are connected to a MIMO controller using one switch), or using a plurality of switches (as shown in FIG. 2C, an AP 2 is connected to a MIMO controller using two switches, and as shown in FIG. 2D, an AP 2 is connected to a MIMO controller using three switches). When the AP is connected to the MIMO controller using a plurality of switches, every two switches may be directly connected (as shown in FIG. 2C, a switch 1 is directly connected to a switch 2, and as shown in FIG. 2D, a switch 3 is directly connected to both a switch 1 and a switch 2), or may be connected using a router (as shown in FIG. 2E, a switch 1 is connected to a switch 2 using a router 1). A connection between switches and a connection between a switch and a router are wired/wireless connections.

The MIMO controller may be an independent device or may be integrated into an AP controller (AC). When the MIMO controller is an independent device, the MIMO controller usually runs on a general-purpose computer, for example, runs on a central processing unit (CPU) of the computer, and performs hardware (such as a CPU hard core, a graphics processing unit (GPU), or a field programmable gate array (FPGA)) acceleration. When the MIMO controller is integrated into an AC, the MIMO controller is usually used as a functional module of the AC. The MIMO controller communicates with an AP using a communications tunnel between the AP and the AC.

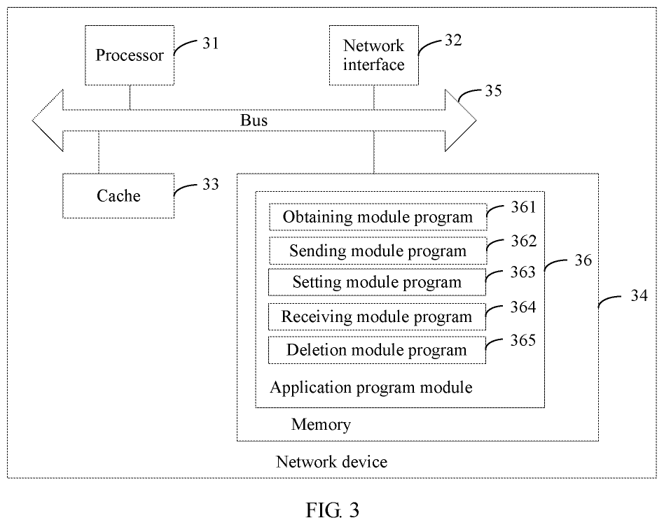

FIG. 3 is a schematic structural diagram of a network device to which an example embodiment of this application is applied. The network device includes a processor 31, a network interface 32, a cache 33, a memory 34, and a bus 35.

The processor 31 includes one or more processing cores. The processor 31 runs a software program and a module, to implement various functional applications and data processing.

The network interface 32 is used by the network device to communicate with another network device.

The memory 34 and the cache 33 are both connected to the processor 31 through the bus 35.

The memory 34 may be configured to store the software program and the module.

The memory 34 may store an application program module 36 required by at least one function. The application program module 36 includes at least an obtaining module program 361, a sending module program 362, a setting module program 363, a receiving module program 364, and a deletion module program 365.

The obtaining module program 361 is configured to obtain first acknowledgment frame delay duration corresponding to a first mobile STA, and obtain second acknowledgment frame delay duration corresponding to a second STA, where the second STA and the first STA are STAs in a same group.

The sending module program 362 is configured to send, to the first STA, a first indication frame carrying the first acknowledgment frame delay duration such that the first STA feeds back an acknowledgment frame after a delay of the first acknowledgment frame delay duration when receiving a data frame, send, to the second STA, a second indication frame carrying the second acknowledgment frame delay duration such that the second STA feeds back an acknowledgment frame after a delay of the second acknowledgment frame delay duration when receiving a data frame, send the first acknowledgment frame delay duration to a first access point AP such that the first AP forwards the first acknowledgment frame delay duration to the first STA, where the first AP is an AP associated with the first STA, send a use count to the first AP such that the first AP forwards the use count to the first STA, send, to the first STA in a form of an aggregated frame, the first indication frame carrying the first acknowledgment frame delay duration, where the aggregated frame further includes a data frame, after sending the data frame to the first STA, re-send the data frame to the first STA if no data frame fed back by the first STA is received within first acknowledgment timeout duration, and when a first acknowledgment timeout duration cancelation message for the first STA that is sent by a MIMO controller is received, send a first acknowledgment frame delay duration cancelation message to the first STA such that the first STA deletes the stored first acknowledgment frame delay duration.

The setting module program 363 is configured to, before the first acknowledgment frame delay duration corresponding to the first mobile STA is obtained, allocate the first acknowledgment frame delay duration to the first STA, after allocating the first acknowledgment frame delay duration to the first STA, set the use count of the first acknowledgment frame delay duration, and set, based on the first acknowledgment timeout duration, the first acknowledgment frame delay duration corresponding to the first STA, where the first acknowledgment timeout duration is longer than the first acknowledgment frame delay duration.

The receiving module program 364 is configured to, before the first acknowledgment frame delay duration corresponding to the first mobile STA is obtained, receive the first acknowledgment timeout duration corresponding to the first STA that is sent by the MIMO controller, and add the first STA and the first acknowledgment timeout duration to a prestored correspondence between a STA and acknowledgment timeout duration.

The deletion module program 365 is configured to delete the first STA and the first acknowledgment timeout duration from the correspondence.

The memory 34 may be implemented by any type of volatile or nonvolatile storage device or a combination thereof, such as a static random access memory (SRAM), a read-only memory (ROM), a programmable ROM (PROM), an erasable PROM (EPROM), an electrically EPROM (EEPROM), a magnetic memory, a flash memory, a magnetic disk, or an optical disc.

A person skilled in the art may understand that the structure of the network device shown in FIG. 3 constitutes no limitation on the network device, and the network device may include more or fewer components than those shown in the figure, or combine some components, or have different component arrangements.

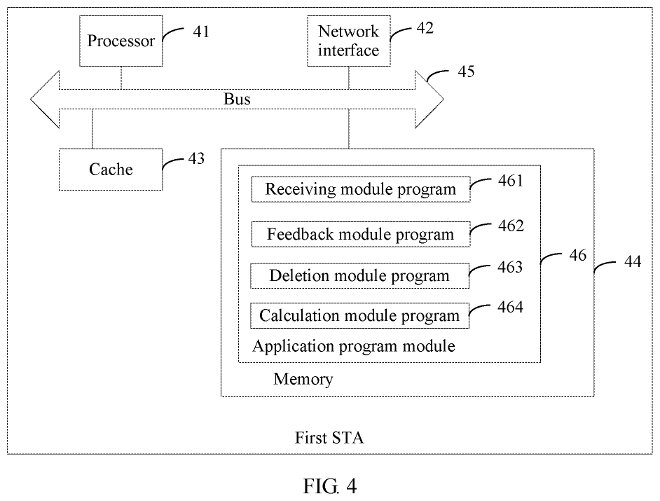

FIG. 4 is a schematic structural diagram of a first STA to which an example embodiment of this application is applied. The first STA includes a processor 41, a network interface 42, a cache 43, a memory 44, and a bus 45.

The processor 41 includes one or more processing cores. The processor 41 runs a software program and a module, to implement various functional applications and data processing.

The network interface 42 is used by the first STA to communicate with another network device.

The memory 44 and the cache 43 are both connected to the processor 41 through the bus 45.

The memory 44 may be configured to store the software program and the module.

The memory 44 may store an application program module 46 required by at least one function. The application program module 46 includes at least a receiving module program 461, a feedback module program 462, a deletion module program 463, and a calculation module program 464.

The receiving module program 461 is configured to receive a first indication frame sent by a first AP, and obtain and store first acknowledgment frame delay duration corresponding to the first STA that is carried in the first indication frame, where the first AP is an AP associated with the first STA, and obtain and store the first acknowledgment frame delay duration corresponding to the first STA and a use count corresponding to the first acknowledgment frame delay duration that are carried in the first indication frame.

The feedback module program 462 is configured to, each time a data frame sent by the first AP is received, feed back an acknowledgment frame to the first AP after a delay of the first acknowledgment frame delay duration, subtract 1 from the stored use count corresponding to the first acknowledgment frame delay duration, and if a result obtained after 1 is subtracted from the use count corresponding to the first acknowledgment frame delay duration is less than 0, delete the first acknowledgment frame delay duration and the use count corresponding to the first acknowledgment frame delay duration, and feed back the acknowledgment frame to the first AP after a delay of default delay duration, or if a result obtained after 1 is subtracted from the use count corresponding to the first acknowledgment frame delay duration is not less than 0, feed back the acknowledgment frame to the first AP after a delay of the first acknowledgment frame delay duration.

The deletion module program 463 is configured to, when a first acknowledgment frame delay duration cancelation message sent by the first AP is received, delete, the stored first acknowledgment frame delay duration.

The calculation module program 464 is configured to, each time a data frame sent by the first AP is received, subtract, 1 from the stored use count corresponding to the first acknowledgment frame delay duration.

The memory 44 may be implemented by any type of volatile or nonvolatile storage device or a combination thereof, such as an SRAM, an EEPROM, an EPROM, a PROM, a ROM, a magnetic memory, a flash memory, a magnetic disk, or an optical disc.

A person skilled in the art may understand that the structure of the first STA shown in FIG. 4 constitutes no limitation on the first STA, and the first STA may include more or fewer components than those shown in the figure, or combine some components, or have different component arrangements.

### Embodiment 1

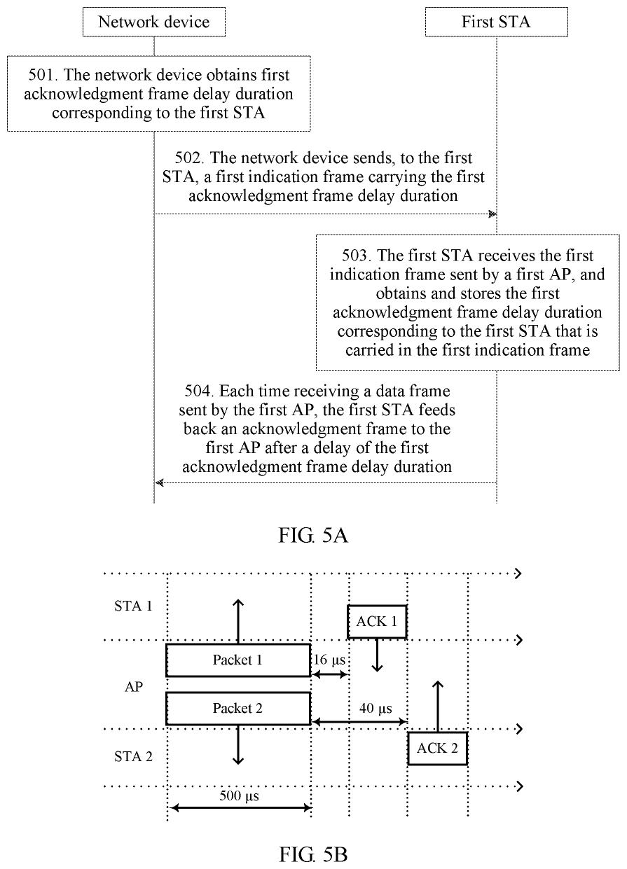

FIG. 5A is a flowchart of an acknowledgment frame delay duration setting method according to an example embodiment of this application. In this embodiment, an example in which the method is used in the system architecture of the acknowledgment frame delay duration setting system shown in FIG. 2A is used for description. As shown in FIG. 5A, the method includes the following several steps.

Step 501: A network device obtains first acknowledgment frame delay duration corresponding to a first STA.

The network device is a MIMO controller or a first AP, and the first AP is an AP associated with the first STA.

When the network device is the MIMO controller, before obtaining the first acknowledgment frame delay duration corresponding to the first STA, the network device allocates the first acknowledgment frame delay duration to the first STA.

Optionally, the MIMO controller allocates the corresponding first acknowledgment frame delay duration to the first STA based on a network delay of the first STA.

When the network device is the first AP, the network device receives the first acknowledgment frame delay duration corresponding to the first STA that is sent by the MIMO controller.

The first STA sends an association request to the first AP. After receiving the association request sent by the first STA, the first AP determines that the first STA is to be associated with the first AP. In this case, the first AP obtains the first acknowledgment frame delay duration corresponding to the first STA.

Step 502: The network device sends, to the first STA, a first indication frame carrying the first acknowledgment frame delay duration.

When the network device is the MIMO controller, the network device sends the first acknowledgment frame delay duration to the first AP such that the first AP forwards the first acknowledgment frame delay duration to the first STA.

When the network device is the first AP, the network device sends, to the first STA, the first indication frame carrying the first acknowledgment frame delay duration.

Management frame subtypes 1101 (Action) and 1110 (Action No ACK) are used for the first indication frame carrying the first acknowledgment frame delay duration. A difference between the two subtypes lies in that, when receiving an Action frame, the first STA needs to reply to the first AP with an acknowledgment frame, but when receiving an Action No ACK frame, the first STA does not need to reply to the first AP with an acknowledgment frame. The Action frame helps provide reliable transmission, and the Action No ACK frame helps reduce network overheads.

An example in which the first indication frame is of the Action type is used below for description. The Action No ACK type has a similar principle to the Action type, and therefore is not described in this embodiment.

The Action frame includes two main fields: a category (Category) field, used to indicate a specific subtype of the Action frame, and a description (Action Details) field, used to describe the Action frame.

Table 1 shows possible values of code in the category field of the Action frame.

TABLE 1

| | | | | Group |
|---|---|---|---|---|
| | | See | | addressed |
| Code | Meaning | subclause | Robust | privacy |
| 14 | Multihop | 8.5.18 | Yes | Yes |
| 15 | Self-protected | 8.5.16 | No | No |
| 16 | Reserved | — | — | — |
| 17 | Reserved (used by WI-FI | — | — | — |
| | ALLIANCE (WFA)) | | | |
| 18-125 | Reserved | — | — | — |
| 126 | Vendor-specific Protected | 8.5.6 | Yes | No |
| 127 | Vendor-specific | 8.5.6 | No | No |
| 128-255 | Error | — | — | — |

It should be noted that, any value that is of the code in Table 1 and that is not defined in an existing protocol or that has no agreed meaning may be used in the category field of the Action frame. For example, the code in the category field of the Action frame is 16.

In a possible implementation, after obtaining the first acknowledgment frame delay duration corresponding to the first STA, when sending a data frame to the first STA, the first AP may form an aggregated frame using the first indication frame and the data frame and then send the aggregated frame to the first STA. Overheads of a frame preamble, a frame header, and the like are reduced due to use of the aggregated frame such that network overheads can be effectively reduced.

When the network device is the first AP, step 502 may be replaced with the following step. The first AP sends, to the first STA in a form of an aggregated frame, a first indication frame carrying the first acknowledgment frame delay duration, where the aggregated frame further includes a data frame.

Further, the first indication frame and the data frame are sent through aggregation using an aggregate media access control (MAC) protocol data unit (A-MPDU).

For example, it is assumed that after the first AP determines the first acknowledgment frame delay duration corresponding to the first STA, there are two data frames that need to be sent to the first STA. In this case, the first AP aggregates the two data frames to obtain downlink data, as shown in Table 2.

TABLE 2

| | |
|---|---|
| A-MPDU subframe 2 | A-MPDU subframe 3 |
| Data frame | Data frame |

Table 3 shows a possible location of the first indication frame in data frames in an aggregated frame obtained after the first indication frame and the data frames are aggregated. It should be noted that, the location of the first indication frame in the data frames is not limited in this embodiment.

When sending the first data frame to the first STA, the first AP sends the data frame and the first indication frame to the first STA through aggregation. Overheads of a frame preamble, a frame header, and the like can be reduced due to use of the aggregated frame such that network overheads can be effectively reduced.

In addition, if the first AP exchanges no information with the first STA when a network MIMO mode ends, the step of sending the first indication frame may be omitted, to reduce the network overheads.

Step 503: The first STA receives the first indication frame sent by the first AP, and obtains and stores the first acknowledgment frame delay duration corresponding to the first STA that is carried in the first indication frame.

It should be noted that, when the first AP sends, to the first STA in the form of the aggregated frame, the first indication frame carrying the first acknowledgment frame delay duration, the first STA receives the aggregated frame sent by the first AP, to obtain the first indication frame and the data frame that are included in the aggregated frame, and feeds back an acknowledgment frame to the first AP after a delay of the first acknowledgment frame delay duration.

Step 504: Each time receiving a data frame sent by the first AP, the first STA feeds back an acknowledgment frame to the first AP after a delay of the first acknowledgment frame delay duration.

STAs usually correspond to different acknowledgment frame delay duration. After receiving a data frame sent by the first AP, each STA feeds back an acknowledgment frame to the first AP after a delay of corresponding acknowledgment frame delay duration. Because an interval between a time at which each STA receives the data frame and a time at which the STA determines to send the acknowledgment frame to the first AP is very short and is even 0, the first AP does not need to send a query request to each STA. Therefore, an occupation time of a large quantity of block acknowledgment (BA) requests (BARs), an SIFS between a BAR and a BA message, a backoff time between acknowledgment frames, and a time for receiving, by the first AP after message retransmission is caused due to a data conflict, an acknowledgment frame with which the STA replies again can be effectively saved.

FIG. 5B is a schematic diagram of acknowledgment frames received by a first AP according to an example embodiment of this application. The first AP sets acknowledgment frame delay duration corresponding to a STA 1 to 16 microseconds (μs), and sets acknowledgment frame delay duration corresponding to a STA 2 to 40 μs. As shown in FIG. 5B, the first AP simultaneously sends data frames to the STA 1 and the STA 2, and a data stream length is 500 μs. After receiving a data frame, the STA 1 feeds back an acknowledgment frame to the first AP after a delay of 16 μs. After receiving a data frame, the STA 2 feeds back an acknowledgment frame to the first AP after a delay of 40 μs.

According to the acknowledgment frame delay duration setting method provided in this embodiment of this application, the network device sends, to the first STA, the first indication frame carrying the first acknowledgment frame delay duration such that when receiving a data frame sent by the first AP associated with the first STA, the first STA feeds back an acknowledgment frame to the first AP after a delay of the first acknowledgment frame delay duration. Because STAs in a same group usually have different acknowledgment frame delay duration, a same AP does not simultaneously receive acknowledgment frames sent by STAs in a same group. This prevents an AP from incorrectly determining, due to a conflict between an acknowledgment frame and a data frame and a conflict between acknowledgment frames, that the AP receives no acknowledgment frame sent by a STA, thereby eliminating polling overheads of the AP, and avoiding a waste of wireless communications resources.

### Embodiment 2

In other approaches, after receiving a data frame, a STA usually needs to feed back an acknowledgment frame to a first AP after an SIFS. Because an acknowledgment timeout time of the first AP is set for the short interframe space, after acknowledgment frame delay duration is allocated to each STA, acknowledgment timeout duration of the first AP for each STA further needs to be set based on the acknowledgment frame delay duration of each STA, to prevent the first AP from prematurely determining that data is lost and starting a re-sending procedure.

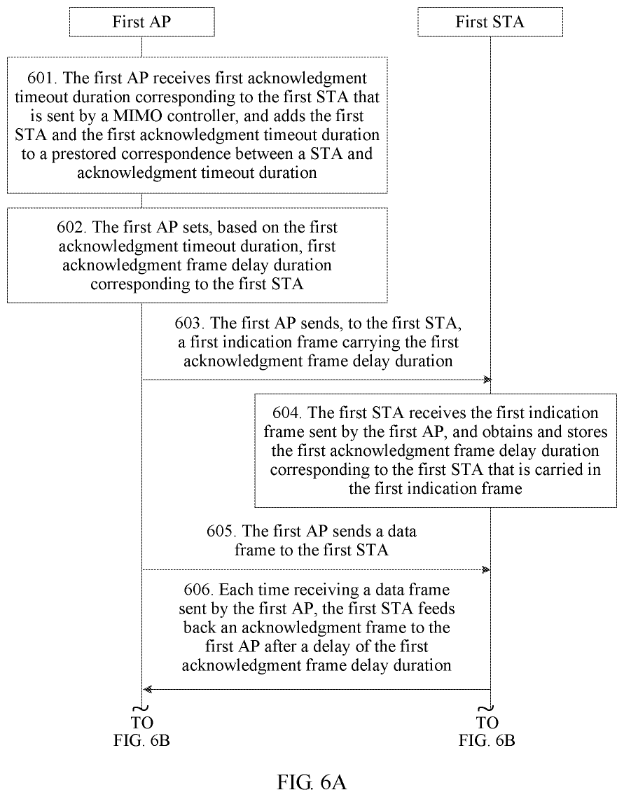

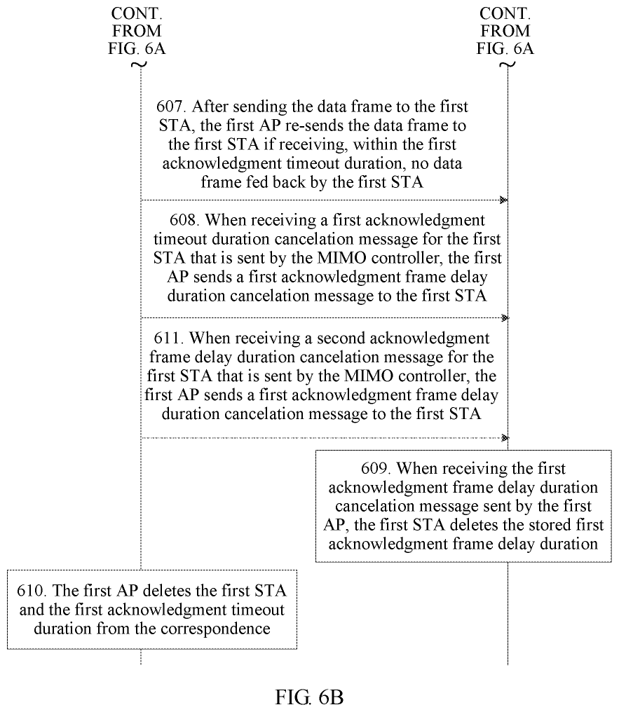

FIG. 6A and FIG. 6B are a flowchart of an acknowledgment frame delay duration setting method according to another example embodiment of this application. In this embodiment, an example in which the method is used in the system architecture of the acknowledgment frame delay duration setting system shown in FIG. 2A is used for description. The method includes the following several steps.

Step 601: A first AP receives first acknowledgment timeout duration corresponding to a first STA that is sent by a MIMO controller, and adds the first STA and the first acknowledgment timeout duration to a prestored correspondence between a STA and acknowledgment timeout duration.

For example, the first AP receives first acknowledgment frame delay duration of 80 μs corresponding to the first STA that is sent by the MIMO controller, and sets the first acknowledgment timeout duration corresponding to the first STA to 100 μs based on the first acknowledgment frame delay duration.

It should be noted that, the MIMO controller may set different acknowledgment timeout duration for different STAs, or may set same acknowledgment timeout duration for different STAs. When same acknowledgment timeout duration is set for different STAs, the acknowledgment timeout duration is longer than acknowledgment frame delay duration corresponding to a STA having the longest acknowledgment frame delay duration.

Table 4 shows that the MIMO controller may set different acknowledgment timeout duration for different STAs connected to a same AP.

TABLE 4

| AP | STA | Acknowledgment timeout duration (μs) |
|---|---|---|
| AP 1 | STA 1 | 36 |
| AP 1 | STA 2 | 50 |

Table 5 shows that the MIMO controller may set same acknowledgment timeout duration for different STAs connected to a same AP.

TABLE 5

| AP | STA | Acknowledgment timeout duration (μs) |
|---|---|---|
| AP 1 | STA 1 | 50 |
| AP 1 | STA 2 | 50 |

Optionally, the MIMO controller sends, to the first AP in a type-length-value (TLV) format, the first acknowledgment timeout duration corresponding to the first STA.

Optionally, to improve reliability of MIMO communication, after receiving the first acknowledgment timeout duration corresponding to the first STA that is sent by the MIMO controller, the first AP feeds back an acknowledgment setting message to the MIMO controller.

It should be noted that, to ensure the reliability of MIMO communication, the first AP may reply to the MIMO controller with a complex acknowledgment message carrying information related to the first STA. To reduce network overheads, the first AP may alternatively reply to the MIMO controller with a brief acknowledgment message carrying no original setting.

For example, the MIMO controller sends, to the first AP, the first acknowledgment timeout duration and the first acknowledgment frame delay duration that correspond to the first STA, where a MAC address of the first STA is 0x0A1122334455, the first acknowledgment frame delay duration is 50 μs, and the first acknowledgment timeout duration is 100 μs.

The MIMO controller sends, to the first AP, a setting message that carries the first acknowledgment timeout duration and indicates that the first AP does not need to feed back the acknowledgment setting message. Table 6 shows a possible message format of the setting message (a time unit is μs).

TABLE 6

| Type | Len | Value |
|---|---|---|
| 00 (message type) | 1 | 0 (indicating a setting request) |
| 01 (message identifier) | 2 | Message identifier (ID) |
| 02 (MAC address of the first | 6 | 0x0A1122334455 |
| STA) | | |
| 03 (acknowledgment frame | 2 | 50 |
| delay duration) | | |
| 04 (acknowledgment timeout | 2 | 100 |
| duration) | | |
| 05 (whether an | 1 | 0 (no acknowledgment is required) |
| acknowledgment | | |
| message needs | | |
| to be replied | | |
| with) | | |
| . . . | . . . | . . . |

The MIMO controller sends, to the first AP, a setting message that carries the first acknowledgment timeout duration and indicates that the first AP needs to feed back the complex acknowledgment message. Table 7 shows a possible message format of the setting message (a time unit is μs).

TABLE 7

| Type | Len | Value |
|---|---|---|
| 00 (message type) | 1 | 1 (indicating a setting reply) |
| 01 (message identifier) | 2 | Message ID |
| 02 (MAC address of the first STA) | 6 | 0x0A1122334455 |
| 03 (first acknowledgment frame | 2 | 50 |
| delay duration) | | |
| 04 (first acknowledgment timeout | 2 | 100 |
| duration) | | |
| 05 (whether an acknowledgment | 1 | 1 (complex acknowledgment) |
| message needs to be replied with) | | |
| . . . | . . . | . . . |

The MIMO controller sends, to the first AP, a setting message that carries the first acknowledgment timeout duration and indicates that the first AP needs to feed back the brief acknowledgment message. Table 8 shows a possible message format of the setting message (a time unit is μs).

TABLE 8

| Type | Len | Value |
|---|---|---|
| 00 (message type) | 1 | 1 (indicating a setting reply) |
| 01 (message identifier) | 2 | Message ID |
| 02 (MAC address of the first STA) | 6 | 0x0A1122334455 |
| 03 (first acknowledgment frame | 2 | 50 |
| delay duration) | | |
| 04 (first acknowledgment timeout | 2 | 100 |
| duration) | | |
| 05 (whether an | 1 | 2 (brief acknowledgment) |
| acknowledgment | | |
| message needs | | |
| to be replied | | |
| with) | | |
| . . . | . . . | . . . |

It should be noted that, a meaning of each value in Type, Len, and Value in Table 6 to Table 8 is merely a possible representation, and the meaning of each value in Type, Len, and Value is not limited in this embodiment.

Correspondingly, when the first AP receives the setting message that is sent by the MIMO controller and that indicates that the first AP needs to feed back the complex acknowledgment message, a possible message format of the complex acknowledgment message fed back by the first AP is shown in Table 9 (a time unit is μs).

TABLE 9

| Type | Len | Value |
|---|---|---|
| 00 (message type) | 1 | 1 (indicating a complex |
| | | acknowledgment reply) |
| 01 (message identifier) | 2 | Message ID |
| 02 (MAC address of the first STA) | 6 | 0x0A1122334455 |
| 03 (first acknowledgment frame delay | 2 | 50 |
| duration) | | |
| 04 (first acknowledgment timeout | 2 | 100 |
| duration) | | |
| 05 | 1 | 0 |
| . . . | . . . | . . . |

Correspondingly, when the first AP receives the setting message that is sent by the MIMO controller and that indicates that the first AP needs to feed back the brief acknowledgment message, a possible message format of the brief acknowledgment message fed back by the first AP is shown in Table 10 (a time unit is μs).

TABLE 10

| Type | Len | Value |
|---|---|---|
| 00 (message type) | 1 | 2 (indicating a brief |
| | | acknowledgment reply) |
| 01 (message identifier) | 2 | Message ID |
| 05 | 1 | 0 |
| . . . | . . . | . . . |

Optionally, the first AP feeds back the acknowledgment setting message to the MIMO controller in a TLV format.

In a possible implementation, the acknowledgment timeout duration of each STA may also be set by a first AP associated with each STA in addition to the MIMO controller. To be specific, the first AP receives the first acknowledgment frame delay duration corresponding to the first STA that is sent by the MIMO controller, sets, based on the first acknowledgment frame delay duration, the first acknowledgment timeout duration corresponding to the first STA, and adds the first STA and the first acknowledgment timeout duration to the prestored correspondence between a STA and acknowledgment timeout duration.

It should be noted that, the first acknowledgment timeout duration is longer than the first acknowledgment frame delay duration.

Step 602: The first AP sets, based on the first acknowledgment timeout duration, the first acknowledgment frame delay duration corresponding to the first STA.

For example, the first AP receives the first acknowledgment timeout duration of 100 is corresponding to the first STA that is sent by the MIMO controller, and sets the first acknowledgment frame delay duration corresponding to the first STA to 80 μs based on the first acknowledgment timeout duration.

In a possible implementation, the first acknowledgment frame delay duration corresponding to the first STA may also be set by the MIMO controller in addition to the first AP. To be specific, the first AP receives the first acknowledgment frame delay duration corresponding to the first STA that is sent by the MIMO controller, and sends the first acknowledgment frame delay duration to the first STA.

Step 603: The first AP sends, to the first STA, a first indication frame carrying the first acknowledgment frame delay duration.

Step 604: The first STA receives the first indication frame sent by the first AP, and obtains and stores the first acknowledgment frame delay duration corresponding to the first STA that is carried in the first indication frame.

Step 605: The first AP sends a data frame to the first STA.

Optionally, the first AP and the first STA each are provided with two interfaces: a first interface and a second interface. Power consumption on the first interface is greater than power consumption on the second interface.

The first AP sends the first indication frame and the data frame to the STA through a first interface, and listens to and receives, through a second interface, an acknowledgment frame fed back by each STA, to reduce power consumption of the first AP.

Likewise, the first STA feeds back an acknowledgment frame to the first AP through a first interface, and listens to and receives, through a second interface, an indication frame and a data frame that are sent by each first AP. Power consumption on the first interface is greater than power consumption on the second interface, to reduce power consumption of the first STA.

In a possible implementation scenario, when the first AP enters a sleep state, the first AP performs listening through the second interface. When obtaining, through listening, a PS-Poll frame sent by the first STA, the first AP feeds back an acknowledgment frame to the first STA through the second interface.

It should be noted that, when obtaining, through listening, the PS-Poll frame sent by the first STA, the first AP may immediately feed back the acknowledgment frame to the first STA, or may not feed back the acknowledgment frame to the first STA until an environment permits, or may feed back the acknowledgment frame to the first STA when the first AP is in an idle state. An occasion on which the first AP feeds back the acknowledgment frame to the first STA is not limited in this embodiment.

In another possible implementation scenario, when the first STA enters a sleep state, the first STA performs listening through the second interface. When obtaining, through listening, a wake-up frame sent by the first AP, the first STA feeds back an acknowledgment frame to the first AP through the second interface after a delay of the first acknowledgment frame delay duration.

If a plurality of STAs associated with a same AP have a same operating band, and the plurality of STAs have same acknowledgment frame delay duration, the first AP may not simultaneously send data frames or indication frames to the plurality of STAs, to prevent the plurality of STAs from simultaneously feeding back acknowledgment frames to the first AP.

Optionally, after step 602, the first AP adds the first STA and the first acknowledgment frame delay duration to a prestored correspondence between a STA and acknowledgment frame delay duration. In addition, before step 603, the first AP needs to perform the following steps.

S1: Determine whether the first AP needs to simultaneously send data to other STAs.

S2: If the first AP needs to simultaneously send data to other STAs, determine, based on the prestored correspondence between a STA and acknowledgment frame delay duration, whether STAs corresponding to same acknowledgment frame delay duration as the first STA exist in the STAs to which the first AP needs to simultaneously send data frames.

S3: If the STAs to which the first AP needs to simultaneously send the data frames correspond to different acknowledgment frame delay duration, perform the step of sending a data frame to the first STA.

S4: If STAs corresponding to same acknowledgment frame delay duration as the first STA exist in the STAs to which the first AP needs to simultaneously send the data frames, sequentially send data frames to the STAs having the same acknowledgment frame delay duration as the first STA, or if STAs corresponding to same acknowledgment frame delay duration as the first STA exist in the STAs to which the first AP needs to simultaneously send the data frames, first set the acknowledgment frame delay duration of the STAs having the same acknowledgment frame delay duration as the first STA to different acknowledgment frame delay duration, and then send data frames to the STAs whose acknowledgment frame delay duration is reset.

When receiving, again, a first indication frame carrying acknowledgment frame delay duration, the first STA replaces locally stored acknowledgment frame delay duration with the acknowledgment frame delay duration in the first indication frame.

For example, the first STA stores acknowledgment frame delay duration of 90 μs, when receiving a first indication frame that carries acknowledgment frame delay duration of 120 μs and that is sent by the first AP, the first STA obtains the acknowledgment frame delay duration of 120 μs carried in the first indication frame and replaces 90 μs with 120 μs for storage.

It should be noted that, in step S4, the acknowledgment frame delay duration of the STAs may be reset by the MIMO controller, or the acknowledgment frame delay duration of the STAs may be reset by the AP.

It should be noted that, a specific value of a time interval for sequentially sending data frames is not limited in this embodiment.

Step 606: Each time receiving a data frame sent by the first AP, the first STA feeds back an acknowledgment frame to the first AP after a delay of the first acknowledgment frame delay duration.

Step 607: After sending the data frame to the first STA, the first AP re-sends the data frame to the first STA if receiving, within the first acknowledgment timeout duration, no data frame fed back by the first STA.

If receiving, within the first acknowledgment timeout duration corresponding to the first STA, no data frame fed back by the first STA, the first AP determines that the data frame sent to the STA is lost. In this case, the first AP re-sends the data frame to the first STA.

In the solution provided in this embodiment of this application, a network device sends, to the first STA, the first indication frame carrying the first acknowledgment frame delay duration such that when receiving a data frame sent by the first AP associated with the first STA, the first STA feeds back an acknowledgment frame to the first AP after a delay of the first acknowledgment frame delay duration. Because STAs in a same group usually have different acknowledgment frame delay duration, a same AP does not simultaneously receive acknowledgment frames sent by STAs in a same group. This prevents an AP from incorrectly determining, due to a conflict between an acknowledgment frame and a data frame and a conflict between acknowledgment frames, that the AP receives no acknowledgment frame sent by a STA, thereby eliminating polling overheads of the AP, and avoiding a waste of wireless communications resources.

In this embodiment, after the acknowledgment frame delay duration is allocated to each STA, the acknowledgment timeout duration of the first AP for each STA further needs to be set based on the acknowledgment frame delay duration of each STA, to prevent the first AP from prematurely determining that data is lost and starting a re-sending procedure.

In a possible implementation, still referring to FIG. 6A and FIG. 6B, the MIMO controller may actively send a first acknowledgment timeout duration cancelation message to the first AP according to a requirement (for example, after a network MIMO phase ends), to control the first AP to cancel acknowledgment timeout duration for some or all of STAs connected to the first AP.

Step 608: When receiving a first acknowledgment timeout duration cancelation message for the first STA that is sent by the MIMO controller, the first AP sends a first acknowledgment frame delay duration cancelation message to the first STA.

An acknowledgment timeout time for a STA is set by the MIMO controller based on acknowledgment frame delay duration of the STA. To prevent the first AP from prematurely determining that data is lost and starting a re-sending procedure after the MIMO controller cancels the acknowledgment timeout time for the STA, the first AP further needs to cancel the acknowledgment frame delay duration of the first STA after canceling an acknowledgment timeout time corresponding to the first STA such that the first STA and the first AP both restore to a default mechanism.

There are at least two following possible message formats of the first acknowledgment timeout duration cancelation message.

A first possible message format is shown in Table 11, and a new encoding manner is used for the message format of the first acknowledgment timeout duration cancelation message.

TABLE 11

| Type | Len | Value |
|---|---|---|
| 00 (message type) | 1 | 2 (indicating a setting request) |
| 01 (message identifier) | 2 | Message ID |
| 02 (MAC address of the first | 6 | 0x0A1122334455 |
| STA) | | |
| 04 (whether an acknowledgment | 1 | 0 (no acknowledgment is |
| message needs to be replied with) | | required)/1 (complex |
| | | acknowledgment)/2 (brief |
| | | acknowledgment) |
| . . . | . . . | . . . |

Optionally, after deleting the first STA and the first acknowledgment timeout duration from the correspondence, the first AP feeds back an acknowledgment cancelation message to the MIMO controller.

It should be noted that, to ensure reliability of MIMO communication, the first AP may reply to the MIMO controller with a complex acknowledgment message carrying information related to the first STA. To reduce network overheads, the first AP may alternatively reply to the MIMO controller with a brief acknowledgment message carrying no original setting.

Correspondingly, a possible message format of the complex acknowledgment message is shown in Table 12 (a time unit is μs).

TABLE 12

| Type | Len | Value |
|---|---|---|
| 00 (message type) | 1 | 1 (indicating a complex |
| | | acknowledgment reply) |
| 01 (message identifier) | 2 | Message ID |
| 02 (MAC address of the STA) | 6 | 0x0A1122334455 |
| 04 (whether an acknowledgment | 1 | 0 (no acknowledgment is |
| message needs to be replied with) | | required) |
| . . . | . . . | . . . |

Correspondingly, a possible message format of the brief acknowledgment message is shown in Table 13 (a time unit is μs).

TABLE 13

| Type | Len | Value |
|---|---|---|
| 00 (message type) | 1 | 2 (indicating a brief |
| | | acknowledgment reply) |
| 01 (message identifier) | 2 | Message ID |
| 04 (whether an | 1 | 0 (no acknowledgment is |
| acknowledgment message | | required) |
| needs to be replied with) | | |
| . . . | . . . | . . . |

A second possible message format is shown in Table 14. A message format of a setting message is used for the message format of the first acknowledgment timeout duration cancelation message, but the first acknowledgment timeout duration is set to 0 μs.

When receiving the first acknowledgment timeout duration cancelation message for the first STA that is sent by the MIMO controller, the first AP obtains the first acknowledgment timeout duration (0 μs) carried in the first acknowledgment timeout duration cancelation message, and deletes the first STA and the first acknowledgment timeout duration from the correspondence.

TABLE 14

| Type | Len | Value |
|---|---|---|
| 00 (message type) | 1 | 0 (indicating a setting request) |
| 01 (message identifier) | 2 | Message ID |
| 02 (MAC address of the first | 6 | 0x0A1122334455 |
| STA) | | |
| 03 (first acknowledgment | 2 | 0 |
| timeout duration) | | |
| 04 (whether an | 1 | 0 (no acknowledgment is |
| acknowledgment message | | required)/1 (complex |
| needs to be replied with) | | acknowledgment)/2 (brief |
| | | acknowledgment) |
| . . . | . . . | . . . |

Optionally, after deleting the first STA and the first acknowledgment timeout duration from the correspondence, the first AP feeds back an acknowledgment cancelation message to the MIMO controller.

A possible message format of a complex acknowledgment message is shown in Table 15 (a time unit is μs).

TABLE 15

| Type | Len | Value |
|---|---|---|
| 00 (message type) | 1 | 1 (indicating a setting |
| | | reply) |
| 01 (message identifier) | 2 | Message ID |
| 02 (MAC address of the first STA) | 6 | 0x0A1122334455 |
| 03 (first acknowledgment timeout | 2 | 0 |
| duration) | | |
| . . . | . . . | . . . |

A possible message format of a brief acknowledgment message is shown in Table 16 (a time unit is μs).

TABLE 16

| Type | Len | Value |
|---|---|---|
| 00 (message type) | 1 | 2 (indicating a brief |
| | | setting reply) |
| 01 (message identifier) | 2 | Message ID |
| . . . | . . . | . . . |

Optionally, the MIMO controller sends the first acknowledgment timeout duration cancelation message to the first AP in a TLV format, and the first AP feeds back the acknowledgment cancelation message to the MIMO controller in a TLV format.

Optionally, a message type of the first acknowledgment frame delay duration cancelation message is a first indication frame carrying acknowledgment frame delay duration of 0 μs.

Optionally, a message type of the first acknowledgment frame delay duration cancelation message is an Action frame. For example, an Action frame with a category field being 16 and a description field being 3 is defined as a first indication frame for canceling the acknowledgment frame delay duration. When receiving the first acknowledgment timeout duration cancelation message for the first STA that is sent by the MIMO controller, the first AP sends, to the first STA, the Action frame with the category field being 16 and the description field being 3.

Step 609: When receiving the first acknowledgment frame delay duration cancelation message sent by the first AP, the first STA deletes the stored first acknowledgment frame delay duration.

After the first STA deletes the stored first acknowledgment frame delay duration, the first STA restores to a default mechanism, to be specific, each time receiving a data frame sent by the first AP, the first STA feeds back an acknowledgment frame to the first AP after an SIFS.

Optionally, after deleting the stored first acknowledgment frame delay duration, the first STA feeds back an acknowledgment cancelation message to the first AP.

It should be noted that, the STA may feed back the acknowledgment cancelation message to the first AP at a MAC layer using an ACK frame, or may feed back the acknowledgment cancelation message to the first AP at a protocol interaction layer using an Action frame.

Step 610: The first AP deletes the first STA and the first acknowledgment timeout duration from the correspondence.

It should be noted that, an execution location of step 608 to step 610 shown in FIG. 6B is merely a possible implementation. During actual application, step 608 to step 610 may be implemented at any location after step 601. An execution location of step 608 to step 610 in step 601 to step 607 is not limited in this embodiment.

In another possible implementation, still referring to FIG. 6A and FIG. 6B, the MIMO controller may actively send, using the first AP, the first acknowledgment frame delay duration cancelation message to the first STA according to a requirement (for example, after the network MIMO phase ends), to control the STA to cancel the acknowledgment frame delay duration. When the MIMO controller may actively send, using the first AP, the first acknowledgment frame delay duration cancelation message to the first STA according to a requirement, the method includes the following step.

Step 611: When receiving a second acknowledgment frame delay duration cancelation message for the first STA that is sent by the MIMO controller, the first AP sends a first acknowledgment frame delay duration cancelation message to the first STA.

Correspondingly, when receiving the first acknowledgment frame delay duration cancelation message sent by the first AP, the first STA deletes the stored first acknowledgment frame delay duration.

Optionally, the first AP sends, to the first STA in a form of an aggregated frame, a first indication frame for canceling the acknowledgment frame delay duration, where the aggregated frame further includes a data frame.

Optionally, to prevent a network delay of the first STA from being increased due to the first acknowledgment timeout duration corresponding to the first STA, after the first AP sends the first acknowledgment frame delay duration cancelation message to the first STA, the first AP deletes the first STA and the first acknowledgment timeout duration from the correspondence.

It should be noted that, step 611 is implemented before step 609.

### Embodiment 3

A MIMO controller may separately set a use count of an acknowledgment frame delay duration, to control a quantity of times a STA uses the acknowledgment frame delay duration after receiving a data frame.

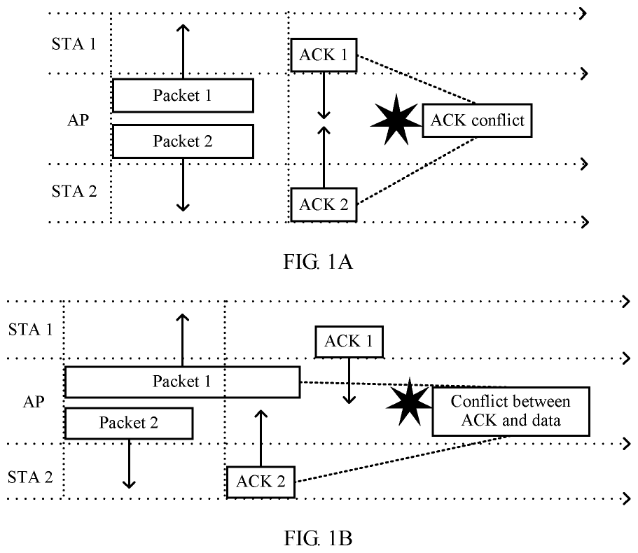

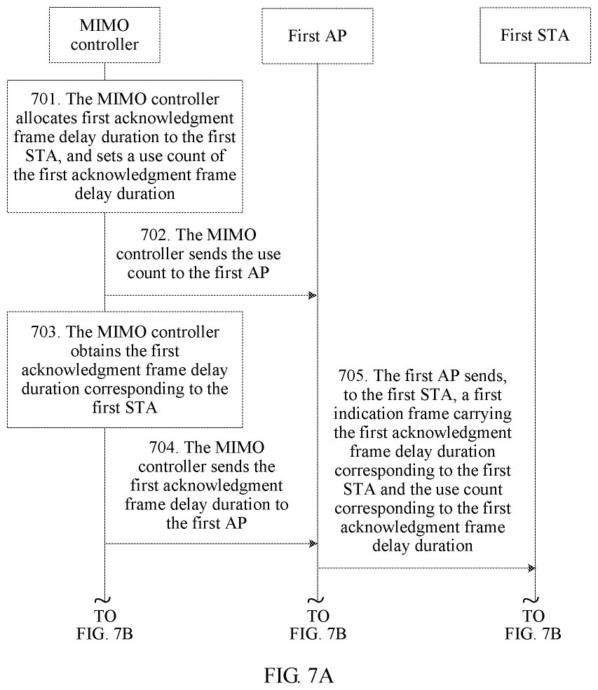

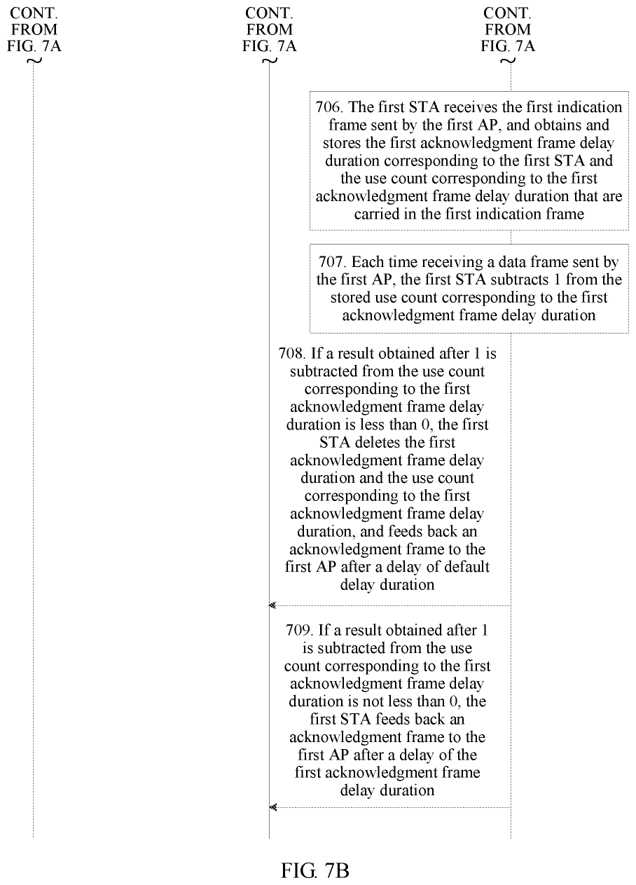

FIG. 7A and FIG. 7B are a flowchart of an acknowledgment frame delay duration setting method according to still another example embodiment of this application. In this embodiment, an example in which the method is used in the system architecture of the acknowledgment frame delay duration setting system shown in FIG. 1 is used for description. The method includes the following several steps.

Step 701: A MIMO controller allocates first acknowledgment frame delay duration to a first STA, and sets a use count of the first acknowledgment frame delay duration.

Step 702: The MIMO controller sends the use count to a first AP.

The first AP is an AP associated with the first STA.

Step 703: The MIMO controller obtains the first acknowledgment frame delay duration corresponding to the first STA.

Step 704: The MIMO controller sends the first acknowledgment frame delay duration to the first AP.

It should be noted that, the MIMO controller may separately send the first acknowledgment frame delay duration and the use count of the first acknowledgment frame delay duration to the first AP, or may combine the first acknowledgment frame delay duration and the use count of the first acknowledgment frame delay duration into one message and then send the message to the first AP.

Step 705: The first AP sends, to the first STA, a first indication frame carrying the first acknowledgment frame delay duration corresponding to the first STA and the use count corresponding to the first acknowledgment frame delay duration.

Optionally, the first indication frame may be used to indicate a single delay or may be used to indicate a plurality of delays. When the first indication frame indicates a single delay, the first acknowledgment frame delay duration carried in the first indication frame can be used only once, or when the first indication frame indicates a plurality of delays, the first indication frame carries the use count corresponding to the first acknowledgment frame delay duration.

It should be noted that, the first indication frame further has a function of canceling the acknowledgment frame delay duration, and different functions are distinguished based on an ACK delay time field (type) in an Action Details field of the first indication frame.

Table 17 shows a possible meaning of the ACK delay time field in the description field of the first indication frame, and the meaning of the ACK delay time field is a meaning of the first indication frame. It should be noted that, a correspondence between an ACK delay time field and a meaning in Table 17 constitutes no limitation on the meaning corresponding to the ACK delay time field.

TABLE 17

| ACK delay time field | Meaning |
|---|---|
| 0 | A delay value is valid for a single time |
| 1 | A delay value is valid for a plurality of times |
| 2 | Cancel a delay value |
| 3 to 255 | Reserved |

Table 18 shows a possible frame format of the first indication frame when the first indication frame is used to indicate a single delay.

TABLE 18

| | Delay time most | Delay time least |
|---|---|---|
| ACK delay time field | significant bit | significant bit |
| 0 (single delay) | 8 time most significant | 8 time least significant |
| | bits | bits |

Table 19 shows a possible frame format of the first indication frame when the first indication frame is used to indicate a plurality of delays.

TABLE 19

| | Delay time | Delay time | Delay count | Delay count |
|---|---|---|---|---|
| | most | least | most | least |
| ACK delay | significant | significant | significant | significant |
| time field | bit | bit | bit | bit |
| 1 (a plurality | 8 time most | 8 time least | 8 time most | 8 time least |
| of delays) | significant | significant | significant | significant |
| | bits | bits | bits | bits |

It should be noted that, the use count is set by the MIMO controller when the MIMO controller allocates the corresponding first acknowledgment frame delay duration to the first STA.

Step 706: The first STA receives the first indication frame sent by the first AP, and obtains and stores the first acknowledgment frame delay duration corresponding to the first STA and the use count corresponding to the first acknowledgment frame delay duration that are carried in the first indication frame.

Step 707: Each time receiving a data frame sent by the first AP, the first STA subtracts 1 from the stored use count corresponding to the first acknowledgment frame delay duration.

Step 708: If a result obtained after 1 is subtracted from the use count corresponding to the first acknowledgment frame delay duration is less than 0, the first STA deletes the first acknowledgment frame delay duration and the use count corresponding to the first acknowledgment frame delay duration, and feeds back an acknowledgment frame to the first AP after a delay of default delay duration.

If the result obtained after 1 is subtracted from the use count corresponding to the first acknowledgment frame delay duration is less than 0, it indicates that the use count has been exhausted before 1 is subtracted from the use count. In this case, the first STA deletes the first acknowledgment frame delay duration and the use count corresponding to the first acknowledgment frame delay duration, and executes a default mechanism, to be specific, feeds back the acknowledgment frame to the first AP after a delay of the default delay duration.

It should be noted that, in this embodiment, when the first STA receives a first acknowledgment frame delay duration cancelation message sent by the first AP, even if the use count corresponding to the first acknowledgment frame delay duration is greater than 0, the first STA still deletes the stored first acknowledgment frame delay duration, and executes the default mechanism.

Step 709: If a result obtained after 1 is subtracted from the use count corresponding to the first acknowledgment frame delay duration is not less than 0, the first STA feeds back an acknowledgment frame to the first AP after a delay of the first acknowledgment frame delay duration.

If the result obtained after 1 is subtracted from the use count corresponding to the first acknowledgment frame delay duration is not less than 0, it indicates that the use count has not been exhausted before 1 is subtracted from the use count. In this case, the first STA feeds back the acknowledgment frame to the first AP after a delay of the first acknowledgment frame delay duration.

It should be noted that, in this embodiment, a subtractive operation is performed on the use count before whether the use count is exhausted is determined. During actual application, whether the use count is exhausted may be determined before a subtractive operation is performed on the use count. In this case, step 707 to step 709 may be replaced with the following step Q1 to step Q3.

Step Q1: Each time receiving a data frame sent by the first AP, the first STA determines whether the stored use count corresponding to the first acknowledgment frame delay duration is 0.

Step Q2: If the stored use count corresponding to the first acknowledgment frame delay duration is 0, the first STA deletes the first acknowledgment frame delay duration and the use count corresponding to the first acknowledgment frame delay duration, and feeds back an acknowledgment frame to the first AP after a delay of default delay duration.

Step Q3: If the stored use count corresponding to the first acknowledgment frame delay duration is not 0, the first STA subtracts 1 from the stored use count corresponding to the first acknowledgment frame delay duration, and feeds back an acknowledgment frame to the first AP after a delay of the first acknowledgment frame delay duration.

In the solution provided in this embodiment of this application, a network device sends, to the first STA, the first indication frame carrying the first acknowledgment frame delay duration such that when receiving a data frame sent by the first AP associated with the first STA, the first STA feeds back an acknowledgment frame to the first AP after a delay of the first acknowledgment frame delay duration. Because STAs in a same group usually have different acknowledgment frame delay duration, a same AP does not simultaneously receive acknowledgment frames sent by STAs in a same group. This prevents an AP from incorrectly determining, due to a conflict between an acknowledgment frame and a data frame and a conflict between acknowledgment frames, that the AP receives no acknowledgment frame sent by a STA, thereby eliminating polling overheads of the AP, and avoiding a waste of wireless communications resources.

In this embodiment, the MIMO controller may separately set the use count of the acknowledgment frame delay duration, to control the quantity of times the STA uses the acknowledgment frame delay duration after receiving the data frame.

### Embodiment 4

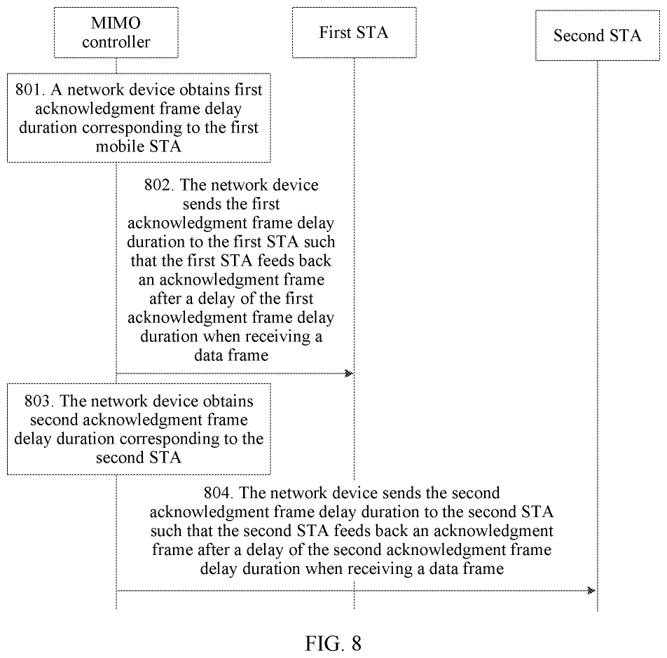

When a plurality of STAs are STAs in a same group, a conflict is likely to be caused between acknowledgment frames simultaneously fed back by the plurality of STAs to an AP. To prevent STAs in a same group from simultaneously feeding back acknowledgment frames to an AP, the plurality of STAs correspond to different acknowledgment frame delay duration. FIG. 8 is a flowchart of an acknowledgment frame delay duration setting method according to yet another example embodiment of this application.

Step 801: A network device obtains first acknowledgment frame delay duration corresponding to a first mobile STA.

Step 802: The network device sends the first acknowledgment frame delay duration to the first STA such that the first STA feeds back an acknowledgment frame after a delay of the first acknowledgment frame delay duration when receiving a data frame.

Step 803: The network device obtains second acknowledgment frame delay duration corresponding to a second STA.

Step 804: The network device sends the second acknowledgment frame delay duration to the second STA such that the second STA feeds back an acknowledgment frame after a delay of the second acknowledgment frame delay duration when receiving a data frame.

It should be noted that, the first STA and the second STA are STAs in a same group, and the two STAs meet at least one of the following cases.

In a first case, the first STA and the second STA are associated with a same AP, and the AP is to simultaneously send data frames to the first STA and the second STA.

In a second case, a first AP associated with the first STA and a second AP associated with second STA have a same operating band, and the second AP also sends a data frame to the second STA when the first AP sends a data frame to the first STA.

When the first STA and the second STA are STAs in a same group, the network device may set different acknowledgment frame delay duration for the first STA and the second STA (that is, the first acknowledgment frame delay duration is different from the second acknowledgment frame delay duration), or set same acknowledgment frame delay duration for the first STA and the second STA (that is, the first acknowledgment frame delay duration is the same as the second acknowledgment frame delay duration), but does not simultaneously send data frames to the first STA and the second STA.

In the solution provided in this embodiment of this application, the first AP sends, to the first STA, a first indication frame carrying the first acknowledgment frame delay duration such that when receiving a data frame sent by the first AP, the first STA feeds back an acknowledgment frame to the first AP after a delay of the first acknowledgment frame delay duration. Because STAs in a same group have different acknowledgment frame delay duration, a same AP does not simultaneously receive acknowledgment frames sent by STAs in a same group. This prevents the first AP from incorrectly determining, due to a conflict between an acknowledgment frame and a data frame and a conflict between acknowledgment frames, that the first AP receives no acknowledgment frame sent by a STA, thereby reducing polling overheads of the first AP, and avoiding a waste of network resources.

In this embodiment, to prevent STAs in a same group from simultaneously feeding back acknowledgment frames to an AP, the plurality of STAs correspond to different acknowledgment frame delay duration.

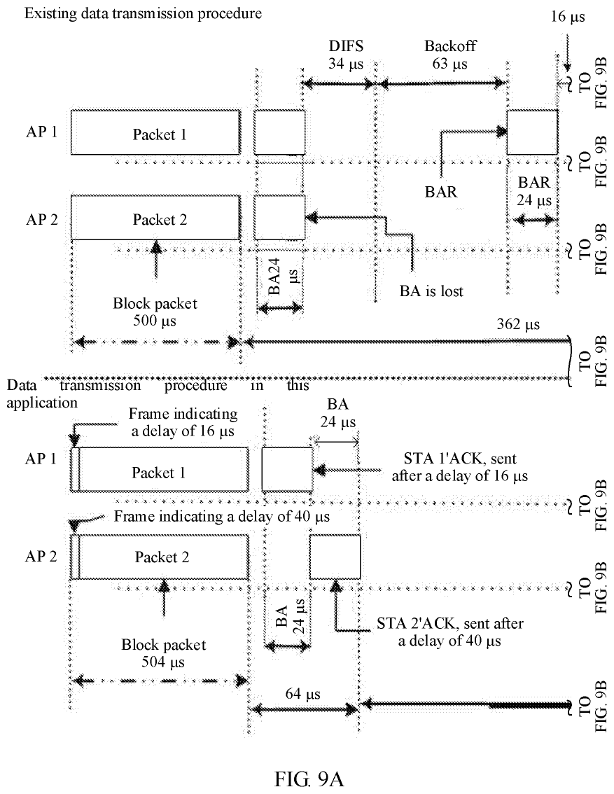

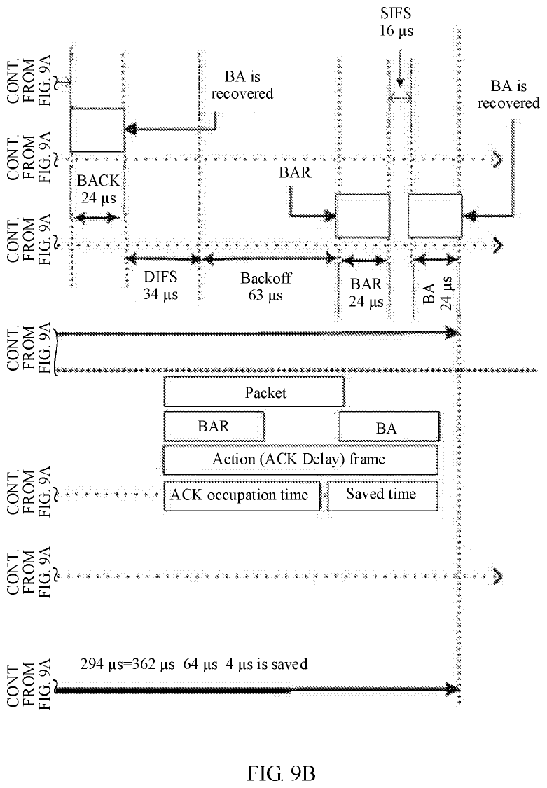

FIG. 9A and FIG. 9B are a schematic diagram of comparison between an existing data transmission procedure and a data transmission procedure in this application according to an example embodiment of this application. As shown in FIG. 9, two APs, two STAs, and a data stream length of 500 μs are used as an example.

In the existing data transmission procedure, after an AP 1 and an AP 2 respectively send data to a STA 1 and a STA 2 at a network MIMO phase (500 μs), the STA 1 and the STA 2 feed back acknowledgment frames (24 μs). In this case, an ACK conflict is caused between the acknowledgment frames fed back by the STA 1 and the STA 2. Because neither the AP 1 nor the AP 2 receives an acknowledgment frame sent by a corresponding STA, the AP 1 and the AP 2 start to contend for an air interface medium (34 μs+63 μs). It is assumed that the AP 1 sends a BAR (24 μs) after obtaining a medium access right, the STA 1 sends a BA (24 μs) after an SIFS after the BAR is sent, and after receiving the BA sent by the STA 1, the AP 1 determines that the STA 1 receives data that is sent by the AP 1 at the network MIMO phase. The AP 2 sends a BAR to the STA 2 (24 μs) after backoff (34 μs+63 μs), the STA 2 sends a BA (24 μs) after an SIFS after the BAR is sent, and after receiving the BA sent by the STA 2, the AP 2 determines that the STA 2 receives data that is sent by the AP 1 at the network MIMO phase.

It can be learned that, once an ACK conflict is caused in the existing data transmission procedure, duration required for determining, by exchanging the BARs and the BAs, whether the STA 1 and the STA 2 receive the data is 362 μs.

In the data transmission procedure in this application, an AP 1 and an AP 2 respectively send data and corresponding first indication frames carrying acknowledgment frame delay duration to a STA 1 and a STA 2 (504 μs). Acknowledgment frame delay duration corresponding to the STA 1 is 16 μs, and acknowledgment frame delay duration corresponding to the STA 2 is 40 μs. After receiving data and a first indication frame that are sent by the AP 1, the STA 1 feeds back an acknowledgment frame to the AP (24 μs) after a delay of 16 μs. After receiving data and a first indication frame that are sent by the AP2, the STA 2 feeds back an acknowledgment frame to the AP (24 μs) after a delay of 40 μs. Both the AP 1 and the AP 2 receive the acknowledgment frames sent by the corresponding STAs.

It can be learned that, in the data transmission procedure in this application, an ACK conflict can be effectively avoided, and duration required for determining whether the STA 1 and the STA 2 receive the data is 64 μs.

Compared with the existing data transmission procedure, in the data transmission procedure in this application, 4 μs is added at a data sending phase, and 298 (362-64) μs is saved at a phase of determining whether the STA 1 and the STA 2 receive the data, and therefore a total of 294 μs is saved in the entire procedure.

The solutions provided in the embodiments of this application are mainly described above from a perspective of interaction between the network device and the STA. It may be understood that, to implement the foregoing functions, the network device and the STA include corresponding hardware structures and/or software modules for performing the functions. The example units and algorithm steps described with reference to the embodiments disclosed in this application can be implemented in a form of hardware or a combination of hardware and computer software in the embodiments of this application. Whether a function is performed by hardware or hardware driven by computer software depends on particular applications and design constraint conditions of the technical solutions. A person skilled in the art may use different methods to implement the described functions for each particular application, but it should not be considered that the implementation falls beyond the scope of the technical solutions in the embodiments of this application.

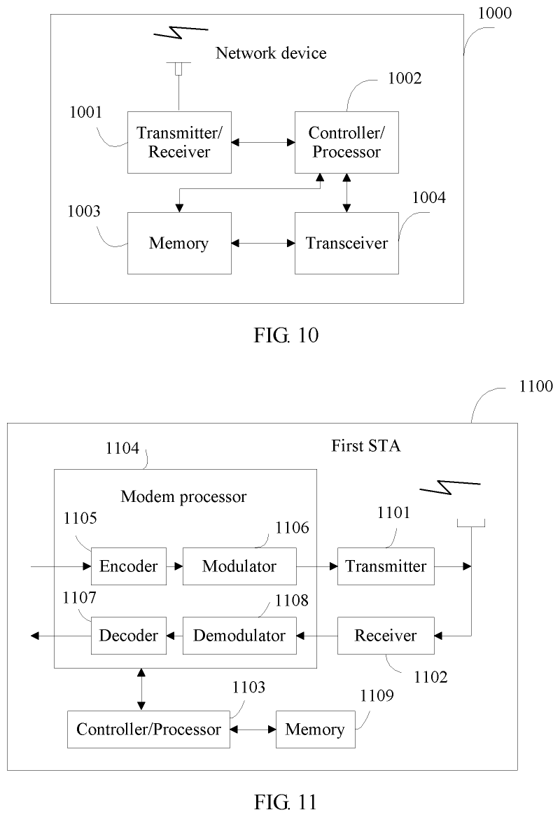

FIG. 10 is a possible schematic structural diagram of a network device 1000 according to an embodiment of this application.

The network device 1000 includes a transmitter/receiver 1001 and a processor 1002. The processor 1002 may also be a controller, and is represented as a “controller/processor 1002” in FIG. 10. The transmitter/receiver 1001 is configured to support the network device in sending information to and receiving information from the STA in the foregoing embodiments, and support the STA in performing radio communication with another STA. The processor 1002 performs various functions for communication with the STA. On an uplink, an uplink signal from the STA is received through an antenna, demodulated by the receiver 1001 (for example, a high frequency signal is demodulated into a baseband signal), and is further processed by the processor 1002 to recover service data and signaling information that are sent by the STA. On a downlink, service data and a signaling message are processed by the processor 1002, and modulated by the transmitter 1001 (for example, a baseband signal is modulated into a high frequency signal) to generate a downlink signal, and the downlink signal is transmitted to the STA through the antenna. It should be noted that, the demodulation or modulation function may be alternatively completed by the processor 1002. For example, the processor 1002 is further configured to perform the process in step 1002 in FIG. 10 and/or another process in the technical solutions described in this application.

Further, the network device 1000 may further include a memory 1003. The memory 1003 is configured to store program code and data of the network device 1000. In addition, the network device may further include a transceiver 1004. The transceiver 1004 is configured to support the network device in communicating with another network entity (for example, a network device in a core network). For example, in a Long-Term Evolution (LTE) system, the transceiver 1004 may be an S1-U interface configured to support the network device in communicating with a Serving Gateway (SGW), or the transceiver 1004 may be an S1-MME interface configured to support the network device in communicating with a Mobility Management Entity (MME).

It may be understood that, FIG. 10 merely shows a simplified design of the network device 1000. During actual application, the network device 1000 may include any quantity of transmitters, receivers, processors, controllers, memories, transceivers, or the like, and all network devices that can implement the embodiments of this application shall fall within the protection scope of the embodiments of this application.

FIG. 11 is a simplified schematic diagram of a possible design structure of a first STA 1100 according to an embodiment of this application. The first STA 1100 includes a transmitter 1101, a receiver 1102, and a processor 1103. The processor 1103 may also be a controller, and is represented as a “controller/processor 1103” in FIG. 11. Optionally, the first STA 1100 may further include a modem processor 1104. The modem processor 1104 may include an encoder 1105, a modulator 1106, a decoder 1107, and a demodulator 1108.

In an example, the transmitter 1101 adjusts (for example, performs analog conversion, filtering, amplification, and up-conversion on) an output sample and generates an uplink signal. The uplink signal is transmitted to the network device in the foregoing embodiments through an antenna. On a downlink, the antenna receives a downlink signal transmitted by the network device in the foregoing embodiments. The receiver 1102 adjusts (for example, performs filtering, amplification, down-conversion, and digitalization on) the signal received from the antenna and provides an input sample. In the modem processor 1104, the encoder 1105 receives service data and a signaling message that are to be sent on an uplink, and processes (for example, formats, encodes, and interleaves) the service data and the signaling message. The modulator 1106 further processes (for example, performs symbol mapping and modulation on) encoded service data and an encoded signaling message, and provides an output sample. The demodulator 1108 processes (for example, demodulates) the input sample and provides a symbol estimate. The decoder 1107 processes (for example, de-interleaves and decodes) the symbol estimate, and provides decoded data and a decoded signaling message that are to be sent to the first STA 1100. The encoder 1108, the modulator 1106, the demodulator 1108, and the decoder 1107 may be implemented by the combined modem processor 1106. These units perform processing based on a radio access technology (for example, access technologies of LTE and other evolved systems) used in a radio access network. It should be noted that, when the first STA 1100 does not include the modem processor 1106, the foregoing functions of the modem processor 1106 may also be implemented by the processor 1103.

The processor 1103 controls and manages an action of the first STA 1100, and is configured to perform a processing process performed by the first STA 1100 in the foregoing embodiments of this application. For example, the processor 1103 is further configured to perform the process in step 604 in FIG. 6A and/or another process in the technical solutions described in this application.

Further, the first STA 1100 may further include a memory 1109. The memory 1109 is configured to store program code and data used for the first STA 1100.

A processor configured to perform a function of the foregoing network device or first STA in the embodiments of this application may be a CPU, a general-purpose processor, a digital signal processor (DSP), an application-specific integrated circuit (ASIC), an FPGA or another programmable logic device, a transistor logic device, a hardware component, or any combination thereof. The processor may implement or execute various example logical blocks, modules, and circuits described with reference to content disclosed in the embodiments of this application. Alternatively, the processor may be a combination implementing a computing function, for example, a combination including one or more microprocessors, or a combination of a DSP and a microprocessor.

Methods or algorithm steps described with reference to the content disclosed in the embodiments of this application may be implemented by hardware, or may be implemented by a processor by executing a software instruction. The software instruction may include a corresponding software module. The software module may be stored in a random access memory (RAM), a flash memory, a ROM, an EPROM, an EEPROM, a register, a hard disk, a removable hard disk, a compact disc ROM (CD-ROM), or any other form of storage medium well-known in the art. An example storage medium is coupled to a processor such that the processor can read information from the storage medium and can write information into the storage medium. Certainly, the storage medium may be a component of the processor. The processor and the storage medium may be located in an ASIC. In addition, the ASIC may be located in the network device or the first STA. Certainly, the processor and the storage medium may exist in the network device or the first STA as discrete components.

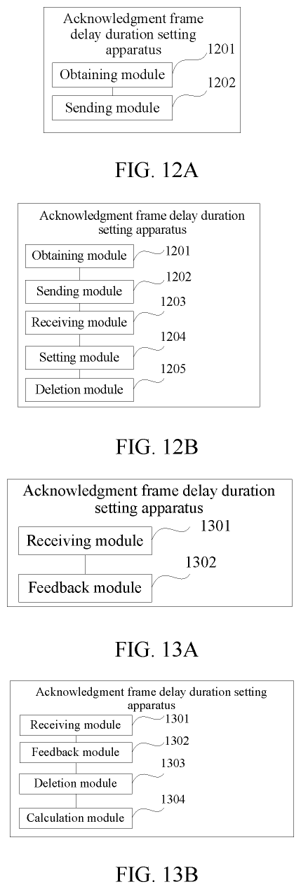

FIG. 12A is a block diagram of an acknowledgment frame delay duration setting apparatus according to an embodiment of this application. The acknowledgment frame delay duration setting apparatus may be implemented as all or a part of a network device using software, hardware, or a combination thereof. The acknowledgment frame delay duration setting apparatus may include an obtaining module 1201 and a sending module 1202.

The obtaining module 1201 is configured to implement the function of step 501.

The sending module 1202 is configured to implement the function of step 502.

For related details, refer to the foregoing method embodiment.

In another optional embodiment, the obtaining module is configured to implement the function of at least one of step 703, step 801, and step 803.

The sending module 1202 is configured to implement the function of at least one of step 603, step 607, step 608, step 611, step 702, step 704, step 705, step 802, and step 804.

FIG. 12B is a block diagram of an acknowledgment frame delay duration setting apparatus according to an embodiment of this application. The acknowledgment frame delay duration setting apparatus may include an obtaining module 1201, a sending module 1202, a receiving module 1203, a setting module 1204, and a deletion module 1205.

The receiving module 1203 is configured to implement the function of step 601.

The setting module 1204 is configured to implement the function of at least one of step 602 and step 701.

The deletion module 1205 is configured to implement the function of step 610.

It should be noted that, the obtaining module 1201 may be implemented by the processor 31 in FIG. 3 by executing the obtaining module program 361 in the memory 34, the sending module 1202 may be implemented by the processor 31 in FIG. 3 by executing the sending module program 362 in the memory 34, the receiving module 1203 may be implemented by the processor 31 in FIG. 3 by executing the receiving module program 364 in the memory 34, the setting module 1204 may be implemented by the processor 31 in FIG. 3 by executing the setting module program 363 in the memory 34, and the deletion module 1205 may be implemented by the processor 31 in FIG. 3 by executing the deletion module program 365 in the memory 34.

FIG. 13A is a block diagram of an acknowledgment frame delay duration setting apparatus according to another embodiment of this application. The acknowledgment frame delay duration setting apparatus may be implemented as all or a part of a first STA using software, hardware, or a combination thereof. The acknowledgment frame delay duration setting apparatus may include a receiving module 1301 and a feedback module 1302.

The receiving module 1301 is configured to implement the function of step 503.

The feedback module 1302 is configured to implement the function of step 504.

For related details, refer to the foregoing method embodiment.

In another optional embodiment, the receiving module 1301 is configured to implement the function of at least one of step 604 and step 706.

The feedback module 1302 is configured to implement the function of at least one of step 606, step 708, and step 709.

FIG. 13B is a block diagram of an acknowledgment frame delay duration setting apparatus according to another embodiment of this application. The acknowledgment frame delay duration setting apparatus may include a receiving module 1301, a feedback module 1302, a deletion module 1303, and a calculation module 1304.

The deletion module 1303 is configured to implement the function of step 609.

The calculation module 1304 is configured to implement the function of step 707.

It should be noted that, the receiving module 1301 may be implemented by the processor 41 in FIG. 4 by executing the receiving module program 461 in the memory 44, the feedback module 1302 may be implemented by the processor 41 in FIG. 4 by executing the feedback module program 462 in the memory 44, the deletion module 1303 may be implemented by the processor 41 in FIG. 4 by executing the deletion module program 463 in the memory 44, and the calculation module 1304 may be implemented by the processor 41 in FIG. 4 by executing the calculation module program 464 in the memory 44.

It should be noted that, when the acknowledgment frame delay duration setting apparatuses provided in the foregoing embodiments set acknowledgment frame delay duration, only division of the foregoing functional modules is used as an example for description. During actual application, the foregoing functions can be allocated to different functional modules for implementation according to a requirement, to be specific, an inner structure of the network device is divided into different functional modules and an inner structure of the STA is divided into different functional modules, to implement all or some of the functions described above. In addition, the acknowledgment frame delay duration setting apparatuses provided in the foregoing embodiments belong to a same concept as the acknowledgment frame delay duration setting method embodiments. For specific implementation processes of the apparatuses, refer to the method embodiments. Details are not described herein again.

The sequence numbers of the foregoing embodiments of this application are merely for illustrative purposes, and are not intended to indicate priorities of the embodiments.

A person of ordinary skill in the art may understand that all or some of the steps in the foregoing embodiments may be implemented by hardware or a program instructing related hardware. The program may be stored in a computer-readable storage medium. The storage medium may be a read-only memory, a magnetic disk, an optical disc, or the like.

The foregoing descriptions are merely optional embodiments of this application, but are not intended to limit this application. Any modification, equivalent replacement, improvement, or the like made without departing from the spirit and principle of this application shall fall within the protection scope of this application.

1. An acknowledgment frame delay duration setting method implemented by a first station (STA), wherein the method comprises:
receiving a first indication frame carrying a first, acknowledgment frame delay duration corresponding to the first ST A from a first access point (AP), wherein the first STA is associated with the first AP,
obtaining and storing the first acknowledgment frame delay duration;
receiving a data frame from the first AP; and
feeding back, in response to the receiving the data frame, an acknowledgment frame to the first AP after a delay of the first acknowledgment frame delay duration.

2. The acknowledgment frame delay duration setting method of claim 1, further comprising:
receiving an aggregated frame from the first AP, wherein the aggregated frame comprises the first indication frame and the data frame; and
feeding back the acknowledgment frame to the first AP after the delay.

3. The acknowledgment frame delay duration setting method of claim 1, wherein the first indication frame further carries a use count corresponding to the first acknowledgment frame delay duration.

4. An acknowledgment frame delay duration setting apparatus comprising:
a processor configured to obtain a first acknowledgment frame delay duration corresponding to a first station (STA); and
a transceiver coupled to the processor and configured to send the first acknowledgment frame delay duration to the first STA to enable the first STA to feed back a first acknowledgment frame after a first delay of the first acknowledgment frame delay duration when receiving a first data frame.

5. The acknowledgment frame delay duration setting apparatus of claim 4, wherein the processor is further configured to obtain a second acknowledgment frame delay duration corresponding to a second ST A, wherein the second ST A and the first STA are in a same group, and wherein the transceiver is further configured to send, to the second STA, a second indication frame carrying the second acknowledgment frame delay duration to enable the second ST A to feed back a second acknowledgment frame after a second delay of the second acknowledgment frame delay duration when receiving a second data frame.

6. The acknowledgment frame delay duration setting apparatus of claim 4, wherein the network device is a multiple-input multiple-output (MIMO) controller, wherein the processor is further configured to allocate the first acknowledgment frame delay duration to the first STA, wherein the transceiver is further configured to send the first acknowledgment frame delay duration to a first access point (AP) to enable the first AP to forward the first acknowledgment frame delay duration to the first STA, and wherein the first STA is associated with the first AP.

7. The acknowledgment frame delay duration setting apparatus of claim 6, wherein the processor is further configured to set a use count of the first acknowledgment frame delay duration and wherein the transceiver is further configured to send the use count to the first AP to enable the first AP to forward the use count to the first STA.

8. The acknowledgment frame delay duration setting apparatus of claim 4, wherein the transceiver is further configured to:
receive a first acknowledgment timeout duration corresponding to the first STA from a multiple-input multiple-output (MIMO) controller; and
add the first STA and the first acknowledgment timeout duration to a prestored correspondence between a STA and an acknowledgment timeout duration,
wherein the processor is further configured to set, based on the first acknowledgment timeout duration, the first acknowledgment frame delay duration corresponding to the first STA, and wherein the first acknowledgment timeout duration is greater than the first acknowledgment frame delay duration.

9. The acknowledgment frame delay duration setting apparatus of claim 8, wherein the transceiver is further configured to send, to the first STA an aggregated framer comprising a first indication frame carrying the first acknowledgment frame delay duration and a data frame.

10. The acknowledgment frame delay duration setting apparatus of claim 9, wherein the transceiver is further configured to:
identify that the transceiver does not receive any data frame from the first STA within the first acknowledgment timeout duration; and
re-send, in response to the identifying, the data frame to the first STA.

11. The acknowledgment frame delay duration setting apparatus of claim 8, wherein the transceiver is further configured to:
receive a first acknowledgment timeout duration cancelation message for the first STA from the MIMO controller; and
send a first acknowledgment frame delay duration cancelation message to the first STA to enable the first STA to delete the first acknowledgment frame delay duration,
wherein the processor is further configured to delete the first ST A and the first acknowledgment timeout duration from the prestored correspondence.

12. An acknowledgment frame delay duration setting apparatus comprising:
a transceiver configured to:
receive a first indication frame from a first access point (AP) carrying a first acknowledgment frame delay duration corresponding to a first STA;
obtain and store the first acknowledgment frame delay duration, wherein the first AP is associated with the first STA; and
receive a data frame from the first AP; and
a processor coupled to the transceiver and configured to feed back feed back, in response to the receiving the data frame, an acknowledgment frame to the first AP after a delay of the first acknowledgment frame delay duration.

13. The acknowledgment frame delay duration setting apparatus of claim 12, wherein the transceiver is further configured to receive an aggregated frame from the first AP to obtain the first indication frame and data frame that are comprised in the aggregated frame, and wherein the processor is further configured to feed back the acknowledgment frame to the first AP after the delay of the first acknowledgment frame delay duration.

14. The acknowledgment frame delay duration setting apparatus of claim 12, wherein the first indication frame further carries a use count corresponding to the first acknowledgment frame delay duration.

15. The acknowledgment frame delay duration setting apparatus of claim 14, wherein the processor is further configured to subtract one from the use count to obtain a result.

16. The acknowledgment frame delay duration setting apparatus of claim 15, wherein the processor is further configured to:
identify that the result is less than zero;
delete the first acknowledgment frame delay duration and the use count; and
feed back the acknowledgment frame to the first AP after a delay of a default delay duration.

17. The acknowledgment frame delay duration setting apparatus of claim 15, wherein the processor is further configured to:
identify that the result is greater than or equal to zero; and
feed back the acknowledgment frame to the first AP after the delay of the first acknowledgment frame delay duration.

18. The acknowledgment frame delay duration setting method of claim 3, further comprising subtracting one from the use count to obtain a result.

19. The acknowledgment frame delay duration setting method of claim 18, further comprising:
identifying that the result is less than zero;
deleting the first acknowledgment frame delay duration and the use count; and
feeding back the acknowledgment frame to the first AP after a delay of a default delay duration.

20. The acknowledgment frame delay duration setting method of claim 18, further comprising:
identifying that the result is greater than or equal to zero; and
feeding back the acknowledgment frame to the first AP after the delay of the first acknowledgment frame delay duration.
